(19) United States
(12) Patent Application Publication
(10) Pub. No.: US 2024/0383808 A1
(43) Pub. Date: Nov. 21, 2024

(54) POST-CONSUMER PLASTIC AS PARTIAL CEMENT REPLACEMENT

(71) Applicant: Government of the United States of America, as represented by the Secretary of Commerce, Gaithersburg, MD (US)

(72) Inventors: Rachel Elizabeth Cook, Damascus, MD (US); Li-Piin Sung, Boyds, MD (US)

(21) Appl. No.: 18/669,371

(22) Filed: May 20, 2024

Related U.S. Application Data
(60) Provisional application No. 63/467,791, filed on May 19, 2023.

(51) Int. Cl. C04B 20/02; C04B 7/02; C04B 18/20; C04B 28/04

(52) U.S. Cl. CPC C04B 20/026; C04B 7/02; C04B 18/20; C04B 28/04

(57) ABSTRACT

The present invention is directed to processes and compositions using post-consumer plastic processed by low temperature milling as a partial cement replacement in a cementitious-based mixture design. The invention discloses ground plastic with a particle size less than or equal to 200 μm as a partial cement replacement at low and high replacement levels for construction applications.

### CROSS-REFERENCE TO RELATED APPLICATION

This application claims the benefit of priority from U.S. Provisional Patent Application Ser. No. 63/467,791, filed on May 19, 2023, the disclosure of which is incorporated herein by reference in its entirety.

### STATEMENT REGARDING FEDERAL RIGHTS

This invention was made with United States Government support from the National Institute of Standards and Technology (NIST), an agency of the United States Department of Commerce. The Government has certain rights in this invention.

### BACKGROUND

In recent years, a focus on eco-friendly and circular economic solutions has become a central talking point in global community conversations. These conversations include environmental and ecological issues as the result of two broadly-used, manmade material categories: ordinary Portland-blended cements (“OPBC”) (e.g., ASTM C595/C595M-21); and plastic waste.

Annually, an estimated 4.1 billion tons of OPBC is produced worldwide, requiring 1.1 GJ of thermal energy and emitting approximately 3.2 to 4.5 billion tons of CO2 as an excess waste product. A common strategy to mitigate the problem of excess release of carbon dioxide during cement production is to limit the amount of OPBC utilized in practice through additions of waste materials to cementitious-based mixture design. These added waste materials have included industrial by-product substitutes, but popularly used (i.e., coal ash-based) substitutes will eventually face reduced availability due to reduced energy production from coal plants. As such, new alternative waste-product substitutions must be investigated.

Meanwhile, the accumulation of plastic waste is an ever-growing problem; that is, global plastic production is expected to reach 600 million tons in 20 years, wherein only an estimated 8-9% of plastics generated within the United States has been recycled in recent years. Though efforts have been made to return waste plastics to monomeric forms via certain depolymerization techniques, it should be noted that this return process is currently extremely energy intensive, inviting the investigation of alternative solutions.

Considering the problem of plastic waste, the inclusion of plastic waste as coarse and fine aggregate in cementitious concrete composites has been investigated. Though the mechanical performance of an end-of-life plastic is highly influenced by initial manufacturing parameters (e.g., blow rate, cooling rate, etc.), the inclusion of end-of-life plastic in concrete as coarse and fine aggregate has largely been successful regardless of variability. For example, plastic has been used as a replacement for coarse aggregate at levels as high as 25% replacement on a volumetric basis, while Marzouk et al. demonstrated that recycled grade-1 could be successfully utilized as a fine aggregate replacement up to 50% while maintaining the required compressive mortar strength at 28 days. Marzouk O Y, Dheilly RM, Queneudec M. Valorization of post-consumer waste plastic in cementitious concrete composites. Waste Manag. 2007; 27 (2): 310-8. However, studies focusing on the utilization of end-of-life plastics as a cement replacement are limited. Schaefer et al. studied the effect of irradiated shredded PET (˜170 μm) when utilized as 1.25% OPC replacement by weight. Schaefer CE, Kupwade-Patil K, Ortega M, Soriano C, Büyüköztürk O, White A E, et al. Irradiated recycled plastic as a concrete additive for improved chemo-mechanical properties and lower carbon footprint. Waste Manag. 2018; 71: 426-39. The compressive strength of cements containing irradiated PET was reported to be higher than 35 MPa after 28 days of hydration in compliance with ASTM C595-21.

### BRIEF DESCRIPTION

Waste plastic has been studied as an aggregate material in OPBC composites and as an OPC replacement at low percentages (˜1-2%) requiring multi-step processing (i.e. shredding and irradiation). This invention is directed to processes and compositions utilizing a novel way to incorporate a large volume of end-of-life plastic waste by upcycling it as a value-added product to replace large quantities of ordinary Portland-blended cements in addition to supplemental cementitious materials (SCMs). This invention is further directed to processes and compositions utilizing a mechanically ground post-consumer plastic (i.e., ≤200 μm) as a partial replacement material for ordinary Portland-blended cements. This invention is further directed to post-consumer plastics which have been processed by low-temperature milling as a partial replacement material for ordinary Portland-blended cements.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows a scheme for the collection, processing, and use of post-consumer plastic as a Portland-blended cement replacement material.

FIG. 2 shows isothermal calorimetry-based determinations of time-dependent heat flow rate in replacements of ordinary Portland cement with post-consumer waste plastic over a 72-hour period following mixing the cement/plastic powder with water.

FIG. 3 shows cumulative heat released over a 72-hour period following mixture for the same samples described in FIG. 2.

FIG. 4 shows cumulative particle size distributions (PSDs, vol. %) of waste plastic ball milled at low temperatures for varying durations (e.g., 0.5 hour, 1.0 hour, and 2.0 hours).

FIG. 5 shows extracted quantitative cumulative frequencies (dᵥₓ, μm) from cumulative PSDs (vol. %) as a function of mill duration (i.e., total grind duration) for the same samples described in FIG. 4.

### DETAILED DESCRIPTION

A detailed description of one or more embodiments is presented herein by way of exemplification and not limitation.

It has been discovered that post-consumer plastics which have been mechanically ground to particulate sizes on-par with dry cement blends (i.e. ≤200 μm) can serve as a partial replacement material for OPC. The mechanical grinding of the post-consumer plastic can be achieved by cryogenic ball-milling, low temperature centrifugal milling, or other variations on low temperature milling, as appropriate (“low temperature milling”).

It has been discovered that the post-consumer plastics processed by low temperature milling to the required size can serve as a partial replacement for OPC while having the mechanical properties needed to be utilized as a cementitious binder in mixture designs for construction applications (e.g., grouts, mortars, or concretes). It has been discovered that the low-temperature milled post-consumer plastics can serve as a replacement at low (e.g., 0%-to-15% of OPC on a weight basis) and high levels (e.g., 15%-to-95% of OPC on a weight basis) while having the necessary mechanical properties needed for use as a cementitious binder.

Low temperature milling as utilized in this invention is mechanical grinding or milling of a material which takes place at less than 0° C. (“processing temperature”). Low temperature milling may also be milling in which the material being processed is maintained at a target temperature of less than 0° C. (“target temperature”). The processing temperature may be less than −50° C., less than −100° C., less than −150° C., or −50 to −200° C. The target temperature may be less than −50° C., less than −100° C., less than −150° C., or −50 to −200° C.

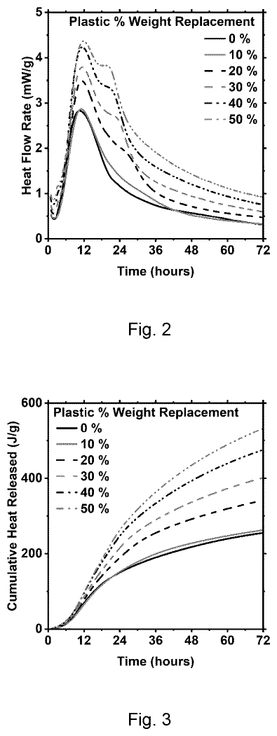

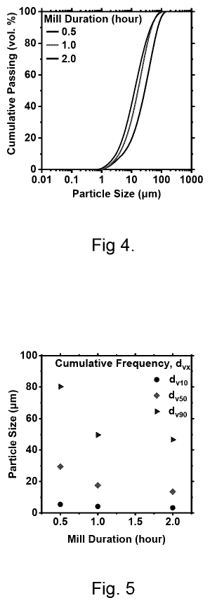

Testing of heat generated during hydration of pastes consisting of various combinations of ordinary Portland cement and low-temperature milled plastics were conducted, as shown in FIGS. 2 and 3. Increases in the ratio of plastic replacement of cement are associated with increases in maximum heat flow rate and cumulative heat released as shown, indicating that the included plastic is contributing to or affecting the hydration reaction. Of note is that a replacement of cement up to 10% by weight of low-temperature milled plastics had substantially similar results in heat flow rate and cumulative heat released as pure cement.

“ASTM” is an acronym that stands for the American Society for Testing and Materials. ASTM C ### refers to ASTM technical document designed for the concrete industry, while ASTM C ###-## refers to the various published versions of that respective technical document.

“Blend” or “-Blended” is to a dry mixture that is composed of at least two separate powdered material (e.g., cementitious, mineral, and/or waste) components.

“Cement” is a fine, soft powder used as a binder because it hardens after contact with water.

“Concrete” is a ceramic composite typically utilized for construction applications. Typically, is a composite mixture composed of cement, water, sand (i.e., fine aggregate), and gravel (i.e., coarse aggregate).

“Grout” is an engineered mortar mixture that typically contains chemical additives to achieve the desired material properties for a given applications.

“Hydration” is the reaction that takes place when the free water in a cement paste is chemically incorporated (i.e., bound) into the microstructure to form a solid, monolithic.

“Matrix” is a homogeneous monolithic material. In the context of this document, this term is meant to indicate a solid (e.g., hydrated) cementitious-based composite. Since plastic is a polymeric material and cement is a ceramic, any general combination of the two could be considered a composite matrix.

“Mortar” is a ceramic composite typically utilized for construction applications; typically, is a composite mixture composed of cement, water, and sand (i.e., fine aggregate).

“Ordinary Portland-blended cements” or “OPBC” is a binary-blended, ternary-blended, quaternary-blended, quinary-blended, etc. dry binder mixtures for construction applications that contain hydraulic OPC. Such dry binder mixtures are now commercially dominant over type I, type II, and type I/II cements.

“Ordinary Portland cement” or “OPC” is a hydraulic material that contains the following phases in the anhydrous stage-alite, belite, tricalcium aluminate, tetracalcium aluminoferrite, blended with one of the calcium sulfate hydrate states (anhydrite, hemihydrate, and/or gypsum).

“Plastic grade” is how post-consumer plastics are sorted for recycling. Plastics are sorted according to their resin identification code. This system categorizes many recyclable plastics into groups numbered 1 through 7. However, recycling of plastics, regardless of grade is confounded by varying compositions and fillers. The plastic grades are as follows: 1. polyethylene terephthalate (PET, PETE); 2. high density polyethylene (HDPE); 3. vinyl (polyvinyl chloride or PVC); 4. low density polyethylene (LDPE); 5. polypropylene (PP). 6. polystyrene; and 7. other.

“Post-consumer plastic” is end-of-life plastic (e.g., following the product's linear lifespan). This term is meant to differentiate from pre-consumer waste materials created during manufacturing.

“Pre-blended” is an ordinary Portland-blended cement that is blended and packaged-typically in sacks-by a manufacturer in order to ensure the desired properties for a particular applications.

“Supplemental cementitious materials” or “SCMs” are materials that, when blended with OPC and ordinary Portland-blended cements (e.g., type IL) participate in hydration processes and/or contribute to a pozzolanic reaction.

“Replacement” or “replacement material” is a powdered material that could be used analogously to an SCM in a cementitious mixture design to create a blended mixture but does not necessarily hydraulically react in the same manner as an SCM. This term can also refer to a filler material that allows for templating of hydration products, but also can refer to an inert filler material.

“Type I cement” is an OPC for general application.

“Type II cement” is an OPC for general application that has moderate sulfate resistance in the field.

“Type IL cement” is a binary blend of OPC with limestone, of which typically 5%-to-15% of OPC is replaced with limestone on a weight basis.

“Type I/II cement” is meant to designate a cement that meets the requirements of both a type I and type II cement and can be used interchangeably.

Post-consumer plastics processed by low temperature milling may be incorporated into an OPBC on a weight basis of 0-5%, 0-10%, 0-15%, 0-25%, 0-50%, 0-75%, 0-95%, 1-5%, 1-10%, 1-15%, 1-25%, 1-50%, 1-75%, 1-95%, 2-5%, 2-10%, 2-15%, 2-25%, 2-50%, 2-75%, 2-95%, 5-10%, 5-15%, 5-25%, 5-50%, 5-75%, 5-95%, 15-25%, 15-50%, 15-75%, or 15-95%.

This invention involves blending (or replacing) OPC and Ordinary Portland-blended cements with mechanically ground post-consumer plastic. The ground post-consumer plastic could be sourced from a single plastic grade or mixed plastic to optimize upcycling capabilities.

This invention also extends to ordinary Portland-blended cements (i.e., binary-blended, ternary-blended, quaternary-blended, quinary-blended, etc.). Some examples of this include, but are not limited to the following:

Binary Blend: OPC+ground post-consumer plastic.

Ternary Blend: OPC+limestone+ground post-consumer plastic.

Ternary Blend: OPC+quartz+ground post-consumer plastic.

Ternary Blend: OPC+rutile+ground post-consumer plastic.

Quaternary Blend: OPC+limestone+low-grade clay+ground post-consumer plastic.

Quaternary Blend: OPC+limestone+calcined clay+ground post-consumer plastic.

Quaternary Blend: OPC+limestone+coal ash+ground post-consumer plastic.

Quaternary Blend: OPC+limestone+waste ash+ground post-consumer plastic.

Quaternary Blend: OPC+limestone+slag+ground post-consumer plastic.

Quinary Blend: OPC+limestone+coal ash+low-grade clay+ground post-consumer plastic.

Quinary Blend: OPC+limestone+waste ash+calcined clay+ground post-consumer plastic.

Quinary Blend: OPC+limestone+coal ash+low-grade clay+ground post-consumer plastic.

Quinary Blend: OPC+limestone+waste ash+calcined clay+ground post-consumer plastic.

In one embodiment, a type IL cement is blended with low-temperature-milled post-consumer plastic. In this embodiment, the post-consumer plastic is incorporated on a weight basis of 0-5%, 0-10%, 0-15%, 0-25%, 0-50%, 0-75%, 0-95%, 1-5%, 1-10%, 1-15%, 1-25%, 1-50%, 1-75%, 1-95%, 2-5%, 2-10%, 2-15%, 2-25%, 2-50%, 2-75%, 2-95%, 5-10%, 5-15%, 5-25%, 5-50%, 5-75%, 5-95%, 15-25%, 15-50%, 15-75%, or 15-95%.

In one embodiment, a low-temperature-milled grade-1 plastic is blended with OPC or a OPBC. In this embodiment, the post-consumer plastic is incorporated on a weight basis of 0-5%, 0-10%, 0-15%, 0-25%, 0-50%, 0-75%, 0-95%, 1-5%, 1-10%, 1-15%, 1-25%, 1-50%, 1-75%, 1-95%, 2-5%, 2-10%, 2-15%, 2-25%, 2-50%, 2-75%, 2-95%, 5-10%, 5-15%, 5-25%, 5-50%, 5-75%, 5-95%, 15-25%, 15-50%, 15-75%, or 15-95%.

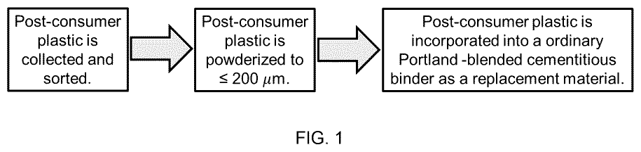

In an embodiment, with reference to FIG. 1, includes:

(1) Post-consumer plastic is collected and sorted. The plastic may be collected and sorted at a waste-processing facility. The plastic may be collected and sorted at a recycling facility. The collection and sorting of plastic may result in a blend of undifferentiated plastic grades, a blend of a selection of plastic grades, or a single plastic grade.

(2) Post-consumer plastic is powderized to ≤200 μm. The post-consumer plastic may be mechanically ground. It may be ground by cryogenic ball-milling, low temperature centrifugal milling, or other variations on low temperature milling, as appropriate. The grinding may occur on-site at the waste processing or recycling facility, allowing for more space-efficient storage and transportation of the post-consumer plastic. The grinding may occur at a cement manufacturer. The grinding may occur at an intermediary between the recycling facility and a cement manufacturer or a consumer.

(3) Post-consumer plastic is incorporated into an OPBC binder as a replacement material. The ground post-consumer plastic may be incorporated into the OBPC at a cement manufacturer as part of a pre-blended mix. The ground post-consumer plastic may be directed used at a local ready-mix facility.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

What is claimed is:

1. A method for producing cement blends, that method comprising:
powderizing post-consumer plastic via low-temperature milling; and
mixing the post-consumer plastic with ordinary Portland cement;
wherein the post-consumer plastic is incorporated into the cement blend replacing the ordinary Portland cement on a weight basis of 2-95%.

2. The method of claim 1, wherein the low-temperature milling is conducted at a processing temperature of less than 0° C.

3. The method of claim 1, wherein the post-consumer plastic is powderized to a particle size of less than 200 μm.

4. The method of claim 1, wherein the post-consumer plastic is powderized such that the particle size distribution is characterized by a dᵥ₅₀ of less than 35 μm.

5. The method of claim 1, wherein the post-consumer plastic is powderized such that the particle size distribution is characterized by a dᵥ₉₀ of less than 80 μm.

6. The method of claim 1, wherein the post-consumer plastic is incorporated into the cement blend, replacing the ordinary Portland cement on a weight basis of 2-20%.

7. The method of claim 1, wherein the post-consumer plastic is incorporated into the cement blend, replacing the ordinary Portland cement on a weight basis of 5-15%.

8. The method of claim 7, wherein peak heat flow rate measured in a sample during hydration is within 10% of an otherwise identical sample where the included post-consumer plastic is replaced with ordinary Portland cement.

9. The method of claim 1, wherein the cement blend further comprises one or more substance selected from: limestone, quartz, rutile, low-grade clay, calcined ash, coal ash, waste ash, or slag.

10. The method of claim 7, wherein the cement blend further comprises one or more substance selected from: limestone, quartz, rutile, low-grade clay, calcined ash, coal ash, waste ash, or slag.

11. The method of claim 8, wherein the cement blend further comprises one or more substance selected from: limestone, quartz, rutile, low-grade clay, calcined ash, coal ash, waste ash, or slag.

12. The method of claim 8, wherein the post-consumer plastic is a grade-1 plastic.

13. The method of claim 8, wherein 5%-to-15% of OPC is replaced with limestone on a weight basis.

14. A cement blend, comprising:
ordinary Portland cement; and
post-consumer plastic powderized via low-temperature milling;
wherein the post-consumer plastic is incorporated into the cement blend replacing the ordinary Portland cement on a weight basis of 2-95%.

15. The cement blend of claim 14, wherein the low-temperature milling is conducted at a processing temperature of less than 0° C.

16. The cement blend of claim 14, wherein the post-consumer plastic is powderized to a particle size of less than 200 μm.

17. The cement blend of claim 14, wherein the post-consumer plastic is powderized such that the particle size distribution is characterized by a dᵥ₅₀ of less than 35 μm.

18. The cement blend of claim 14, wherein the post-consumer plastic is incorporated into the cement blend, replacing the ordinary Portland cement on a weight basis of 5-15%.

19. The cement blend of claim 18, wherein peak heat flow rate measured in a sample during hydration is within 10% of an otherwise identical sample where the included post-consumer plastic is replaced with ordinary Portland cement.

20. The cement blend of claim 19, wherein the cement blend further comprises one or more substance selected from: limestone, quartz, rutile, low-grade clay, calcined ash, coal ash, waste ash, or slag.
